(19) United States
(12) Patent Application Publication
(10) Pub. No.: US 2023/0032362 A1
(43) Pub. Date: Feb. 2, 2023

(54) LITHIUM LANTHANUM ZIRCONIUM OXIDE (LLZO) MATERIALS

(71) Applicant: 6K Inc., North Andover, MA (US)

(72) Inventors: Richard K. Holman, Wellesley, MA (US); Gregory M. Wrobel, North Andover, MA (US)

(21) Appl. No.: 17/813,283

(22) Filed: Jul. 18, 2022

Related U.S. Application Data
(60) Provisional application No. 63/203,810, filed on Jul. 30, 2021.
(60) Provisional application No. 63/273,833, filed on Oct. 29, 2021.

(51) Int. Cl. C01D 15/02; C01G 25/00; C01G 25/02; C01D 15/08; C01G 1/02

(52) U.S. Cl. CPC C01D 15/02; C01G 25/006; C01G 25/02; C01D 15/08; C01G 1/02; C01P 2004/80; C01P 2006/40

(57) ABSTRACT

Disclosed herein are materials and processes for production of lithium oxide materials, such as lithium lanthanum zirconium oxide (LLZO), having a small particle size and high density for use in lithium-ion batteries. Some embodiments are directed to forming and then heating a multiphase material comprising lithium carbonate and La₂Zr₂O₇ in the presence of hydrogen gas at a temperature below the melting point of the lithium carbonate, such that at least a portion of the lithium carbonate decomposes to form lithium oxide. In some embodiments, the lithium oxide is heated to a temperature sufficient to crystallize the lithium oxide to form the solid electrolyte material comprising lithium lanthanum zirconium oxide (LLZO) particles.

### INCORPORATION BY REFERENCE TO ANY PRIORITY APPLICATIONS

This application claims the priority benefit under 35 U.S.C. § 119(e) of U.S. Provisional Application No. 63/203,810, filed Jul. 30, 2021, and Provisional Application 63/273,833, filed Oct. 29, 2021, the entire disclosure of each of which is incorporated herein by reference. Any and all applications for which a foreign or domestic priority claim is identified in the Application Data Sheet as filed with the present application are hereby incorporated by reference under 37 CFR 1.57.

### BACKGROUND

### Field

The present disclosure is generally directed in some embodiments to the manufacture of lithium oxides, including doped and undoped lithium lanthanum zirconium oxide (LLZO) materials, and methods of production.

### Description

In lithium-ion batteries, lithium cobalt oxide is conventionally used as a cathode material. However, many alternative material systems have been developed and used. Generally, lithium and oxygen are an essential part of the material system. Often, cobalt may be completely or partially replaced by other metallic elements such as nickel and manganese. For this reason, most lithium-ion batteries can be described as lithium metal oxide batteries.

Lithium metal oxides are produced as solid powders. The microstructure, morphology, particle size, and degree and type of possible contamination in the powder play a decisive role in the selection of the powder as a suitable material for use as a cathode in a lithium-ion battery. These properties influence the electrochemical characteristics of the battery. In particular, the energy density is of great importance. For example, energy density may affect the distance electric vehicles can drive and is influenced by the above-mentioned microstructural parameters.

The microstructure of the lithium metal oxide material must therefore be precisely adjusted. A lithium metal oxide is a mixed crystal of lithium oxide and oxides of other metals. These mixed crystals are conventionally formed by thermal treatment of a mixture of the individual oxides at high temperatures, typically between 800-1000° C. under certain atmospheric conditions. The individual oxides, in turn, are provided by the addition of various raw materials to the mixture. The starting raw materials are often hydroxides or carbonates of lithium and the other respective metallic elements. By heat treatment of these starting materials water (H₂O) or carbon dioxide (CO₂) is released at high temperatures. The remaining oxides participate later by further treatments in a mixed crystal. Generally, in the manufacturing process of the material, various oxides are extracted from the respective hydroxides or carbonates of the same elements in the first step and then, in a second step, the desired mixed crystal is produced from these oxides.

The first step, in which two solids react together to form a third solid and gases are released, is called calcination. The second step is called sintering or solid diffusion. Calcination occurs almost independently of time as soon as the temperatures and starting materials required for the beginning of the reaction are available. However, often calcination is performed at high temperatures, causing materials to undesirably grow in particle size during the process. Furthermore, achieving a lithium oxide material for a dense film is difficult because of effect of the gas generated during the process.

Thus, new processes for producing lithium oxide materials having a small particle size and high density are needed.

### SUMMARY

Some embodiments herein are directed to a process for producing a solid electrolyte material, the process comprising: heating a multiphase material comprising lithium carbonate in the presence of hydrogen gas at a temperature below the melting point of the lithium carbonate, such that at least a portion of the lithium carbonate decomposes to form lithium oxide; and heating the lithium oxide to a temperature sufficient to crystallize the lithium oxide to form the solid electrolyte material, the solid electrolyte material comprising lithium lanthanum zirconium oxide (LLZO) particles.

In some embodiments, the average particle size of the multiphase material is between about 20 nm and about 1000 nm. In some embodiments, the average particle size of the multiphase material is about 300 nm.

In some embodiments, the multiphase material further comprises lanthanum (La). In some embodiments, the multiphase material further comprises zirconium (Zr). In some embodiments, the multiphase material further comprises lanthanum (La) and zirconium (Zr). In some embodiments, the multiphase material further comprises a lanthanum zirconium oxide. In some embodiments, the multiphase material further comprises La₂Zr₂O₇.

In some embodiments, the LLZO further comprises one or more dopants. In some embodiments, the one or more dopants comprise at least one of aluminum (Al), tantalum (Ta), niobium (Nb), gallium (Ga), or boron (B). In some embodiments, the LLZO further comprises at least one of LaAlO₃ or La₂(Li_{0.5}Al_{0.5})O₄.

In some embodiments, the multiphase material further comprises at least one of LiAlLaO₂, Li₂ZrO₃, ZrO₂, LaAlO₃, Li₂Zr₂O₇, La₂O₃, La₂(Li_{0.5}Al_{0.5})O₄, LiLaO₂, Li₅AlO₄, La₂O₂CO₃, or LiₐZr_{b}O_{c} where 1≤a≤8, 1≤b≤2, and 1≤c≤7.

In some embodiments, the solid electrolyte material further comprises one or more dopants. In some embodiments, the one or more dopants comprise at least one of aluminum (Al), tantalum (Ta), Niobium (Nb), Gallium (Ga), or Boron (B).

In some embodiments, the average particle size of the solid electrolyte material is between about 20 nm and about 1000 nm. In some embodiments, the average particle size of the solid electrolyte material is about 300 nm.

In some embodiments, the portion of the lithium carbonate that decomposes to form lithium oxide is at least 50% by weight of the lithium carbonate in the multiphase material. In some embodiments, the portion of the lithium carbonate that decomposes to form lithium oxide is at least 75% by weight of the lithium carbonate in the multiphase material. In some embodiments, the portion of the lithium carbonate that decomposes to form lithium oxide is at least 90% by weight of the lithium carbonate in the multiphase material. In some embodiments, the portion of the lithium carbonate that decomposes to form lithium oxide is at least 99% by weight of the lithium carbonate in the multiphase material.

In some embodiments, the total time of heating of the multiphase material and the heating of the lithium oxide is between about 2 hours and about 20 hours. In some embodiments, the multiphase material is heated for between about 1 hour and about 10 hours. In some embodiments, the lithium oxide is heated for between about 1 hour and about 10 hours.

In some embodiments, the method further comprises forming a thin film from the solid electrolyte material.

In some embodiments, at least a portion of the lithium carbonate forms lithium peroxide upon heating the multiphase material. In some embodiments, the lithium oxide is heated at a temperature above 600° C. In some embodiments, the lithium oxide is heated to a temperature above 640° C. In some embodiments, the lithium oxide is heated in oxygen-containing atmosphere. In some embodiments, the lithium oxide is heated in the absence of hydrogen gas. In some embodiments, an amount of lithium loss that occurs during the process is less than 3% by weight.

In some embodiments, the method further comprises forming the multiphase material using a microwave plasma process comprising: inputting one or more feedstock materials into a microwave generated plasma to form the multiphase material; and collecting the multiphase material.

Some embodiments herein are directed to a method of producing lithium lanthanum zirconium oxide (LLZO) particles, the method comprising: heating a multiphase material comprising lithium carbonate and La₂Zr₂O₇ in the presence of hydrogen gas at a temperature below the melting point of the lithium carbonate, such that at least a portion of the lithium carbonate decomposes to form lithium oxide; and heating the lithium oxide to a temperature sufficient to crystallize the lithium oxide to form lithium lanthanum zirconium oxide (LLZO) particles.

In some embodiments, the average particle size of the multiphase material is between about 20 nm and about 1000 nm. In some embodiments, the average particle size of the multiphase material is about 300 nm.

In some embodiments, the LLZO further comprises one or more dopants. In some embodiments, the one or more dopants comprise at least one of aluminum (Al), tantalum (Ta), niobium (Nb), gallium (Ga), and boron (B). In some embodiments, the LLZO further comprises at least one of LaAlO₃ or La₂(Li_{0.5}Al_{0.5})O₄.

In some embodiments, the multiphase material further comprises at least one of LiAlLaO₂, Li₂ZrO₃, ZrO₂, LaAlO₃, La₂O₃, La₂(Li_{0.5}Al_{0.5})O₄, LiLaO₂, Li₅AlO₄, La₂O₂CO₃, or LiₐZr_{b}O_{c} where 1≤a≤8, 1≤b≤2, and 1≤c≤7.

In some embodiments, the average particle size of the LLZO is between about 20 nm and about 1000 nm. In some embodiments, the average particle size of the LLZO is about 300 nm.

In some embodiments, the portion of the lithium carbonate that decomposes to form lithium oxide is at least 50% by weight of the lithium carbonate in the multiphase material. In some embodiments, the portion of the lithium carbonate that decomposes to form lithium oxide is at least 75% by weight of the lithium carbonate in the multiphase material. In some embodiments, the portion of the lithium carbonate that decomposes to form lithium oxide is at least 90% by weight of the lithium carbonate in the multiphase material. In some embodiments, the portion of the lithium carbonate that decomposes to form lithium oxide is at least 99% by weight of the lithium carbonate in the multiphase material.

In some embodiments, the total time of heating of the multiphase material and the heating of the lithium oxide is between about 2 hours and about 20 hours. In some embodiments, the multiphase material is heated for between about 1 hour and about 10 hours. In some embodiments, the lithium oxide is heated for between about 1 hour and about 10 hours.

In some embodiments, the method further comprises forming a thin film from the LLZO particles. In some embodiments, at least a portion of the lithium carbonate forms lithium peroxide upon heating the multiphase material.

In some embodiments, the lithium oxide is heated at a temperature above 600° C. In some embodiments, the lithium oxide is heated to a temperature above 640° C. In some embodiments, the lithium oxide is heated in oxygen-containing atmosphere. In some embodiments, the lithium oxide is heated in the absence of hydrogen gas. In some embodiments, an amount of lithium loss that occurs during the process is less than 3% by weight.

In some embodiments, the method further comprises forming the multiphase material using a microwave plasma process comprising: inputting one or more feedstock materials into a microwave generated plasma to form the multiphase material; and collecting the multiphase material.

Some embodiments herein are directed to a method of producing a multiphase material, the method comprising: preparing a feedstock comprising lanthanum and zirconium; introducing the feedstock into a microwave plasma torch, a plasma plume of the microwave plasma torch, and/or an exhaust of the microwave plasma torch; and heating the feedstock within the microwave plasma torch, the plasma plume of the microwave plasma torch, and/or the exhaust of the microwave plasma torch to form the multiphase material, the multiphase material comprising lithium carbonate and lanthanum zirconate.

In some embodiments, the multiphase material further comprises at least one of: lanthanum aluminate, lithium aluminum oxide, and dilanthanum dioxide carbonate. In some embodiments, the multiphase material comprises phases of the lithium carbonate and lanthanum zirconate within a single particle of the multiphase material.

In some embodiments, the method further comprises heating the multiphase material in the presence of hydrogen gas at a temperature below the melting point of the lithium carbonate, such that at least a portion of the lithium carbonate decomposes to form lithium oxide. In some embodiments, the method further comprises heating the lithium oxide to a temperature sufficient to crystallize the lithium oxide to form lithium lanthanum zirconium oxide (LLZO) particles.

Some embodiments herein are directed to a multiphase material comprising lithium carbonate and lanthanum zirconate within a single particle of the multiphase material.

In some embodiments, the multiphase material is formed by a process comprising: preparing a feedstock comprising lanthanum and zirconium; introducing the feedstock into a microwave plasma torch, a plasma plume of the microwave plasma torch, and/or an exhaust of the microwave plasma torch; and heating the feedstock within the microwave plasma torch, the plasma plume of the microwave plasma torch, and/or the exhaust of the microwave plasma torch to form the multiphase material. In some embodiments, the process further comprises heating the multiphase material in the presence of hydrogen gas at a temperature below the melting point of the lithium carbonate, such that at least a portion of the lithium carbonate decomposes to form lithium oxide. In some embodiments, the process further comprises heating the lithium oxide to a temperature sufficient to crystallize the lithium oxide to form lithium lanthanum zirconium oxide (LLZO) particles.

In some embodiments, the multiphase material further comprises at least one of: lanthanum aluminate, lithium aluminum oxide, and dilanthanum dioxide carbonate. In some embodiments, the multiphase material comprises phases of the lithium carbonate and lanthanum zirconate within a single particle of the multiphase material. Some embodiments herein are directed to lithium lanthanum zirconium oxide (LLZO) material formed by a method comprising: heating a multiphase material comprising lithium carbonate and La2Zr2O7 in the presence of hydrogen gas at a temperature below the melting point of the lithium carbonate, such that at least a portion of the lithium carbonate decomposes to form lithium oxide; and heating the lithium oxide to a temperature sufficient to crystallize the lithium oxide to form lithium lanthanum zirconium oxide (LLZO) particles.

### BRIEF DESCRIPTION OF THE DRAWINGS

The drawings are provided to illustrate example embodiments and are not intended to limit the scope of the disclosure. A better understanding of the systems and methods described herein will be appreciated upon reference to the following description in conjunction with the accompanying drawings, wherein:

FIG. 1 illustrates an exemplary microwave plasma torch that can be used in the production of materials, according to some embodiments of the present disclosure

FIGS. 2A-B illustrates an exemplary microwave plasma torch that includes a side feeding hopper.

FIG. 3A is an electron micrograph of a multiphase starting material produced via a microwave plasma process according to some embodiments described herein.

FIG. 3B is a phase identification of a multiphase starting material produced via a microwave plasma process performed via X-ray diffraction according to some embodiments described herein.

FIGS. 4A-B are electron micrographs of LLZO material calcined in the presence of hydrogen gas according to some embodiments described herein.

FIG. 4C is a phase identification of an LLZO material calcined in the presence of hydrogen gas performed via x-ray diffraction according to some embodiments described herein.

FIGS. 5A-B are electron micrographs of LLZO material calcined in the presence of hydrogen and oxygen gas according to some embodiments described herein.

FIG. 5C is a phase identification of an LLZO material calcined in the presence of hydrogen and oxygen, performed via x-ray diffraction according to some embodiments described herein.

FIG. 6 illustrates a table summarizing the stoichiometric properties, particle size, and phases of an LLZO material according to some embodiments herein.

### DETAILED DESCRIPTION

Although certain preferred embodiments and examples are disclosed below, inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present technology.

A promising class of ionically conductive ceramics for solid-state battery cells are based on lithium lanthanum zirconium oxide (LLZO). These materials have room temperature ionic conductivities of up to 10⁻³ S/cm and have excellent electrochemical stability. Embodiments of the disclosure can be incorporated into solid-state batteries, such as in separators, electrodes, anodes, and/or cathodes. These components may benefit from benefit from tight control over the particle size, particle size distribution, and high chemical purity materials, which is advantageously disclosed herein.

Disclosed herein are materials and processes for production of lithium oxide materials, such as LLZO, having a small particle size and high density for use in lithium-ion batteries. In some embodiments, a process according to the embodiments herein may comprise a calcination process in which starting materials are heated in the presence of hydrogen gas, with or without the presence of oxygen. In some embodiments, the starting materials may be synthesized using a microwave plasma process, which may produce a multiphase starting material comprising lithium carbonate and metal oxide having an average particle size between about 20 nm and about 1000 nm. In some embodiments, the multiphase starting material may have an average particle size of about 20 nm, about 40 nm, about 60 nm, about 80 nm, about 100 nm, about 120 nm, about 140 nm, about 160 nm, about 180 nm, about 200 nm, about 220 nm, about 240 nm, about 260 nm, about 280 nm, about 300 nm, about 320 nm, about 340 nm, about 360 nm, about 380 nm, about 400 nm, about 420 nm, about 440 nm, about 460 nm, about 480 nm, about 500 nm, about 520 nm, about 540 nm, about 560 nm, about 580 nm, about 600 nm, about 620 nm, about 640 nm, about 660 nm, about 680 nm, about 700 nm, about 720 nm, about 740 nm, about 760 nm, about 780 nm, about 800 nm, about 820 nm, about 840 nm, about 860 nm, about 880 nm, about 900 nm, about 920 nm, about 940 nm, about 960 nm, about 980 nm, about 1000 nm, or any value between the aforementioned values. In some embodiments, during calcination of the multiphase material (e.g., lithium carbonate/La₂Zr₂O₇ multiphase material), the lithium carbonate of the multiphase material may decompose to form lithium oxide. In some embodiments, the presence of hydrogen gas allows for calcination of the multiphase material at a temperature below the melting point of lithium carbonate. In some embodiments, plasma processing may produce a unique starting multiphase material not attainable by other production methods. Particularly, plasma processing may produce materials comprising mixtures of carbonates and oxides within single particles. Materials sourced using other production processes would instead exhibit separate particles of lithium carbonate and oxides. During heat treatment, plasma processed multiphase material comprising mixed-phase particles will desirably form into LLZO with less sintering/growth than a material made of separate phase particles. In some embodiments, reduced sintering and growth is a benefit in the final LLZO material.

In some embodiments, at least a portion of the lithium carbonate may be converted to lithium oxide via the calcination process, during which the starting multiphase material may be heated at a temperature below the melting point of lithium carbonate. For example, in some embodiments, over 50%, over 60%, over 70%, over 75%, over 80%, over 85%, over 90%, over 95%, over 99%, or over 99% of the lithium carbonate by weight may be converted to lithium oxide during heating of the lithium carbonate in the presence of hydrogen gas. In some embodiments, after at least a portion of the lithium carbonate is converted to lithium oxide, a temperature of the process may be increased to a higher temperature, sometimes above the melting point of lithium carbonate (e.g., above 723° C.), to rapidly crystallize the lithium oxide and metal oxides to grow dense LLZO particles. In some embodiments, a dense LLZO thin film may be formed. In some embodiments, the calcination temperatures used in the processes described herein may be significantly lower than conventional calcination processes due to the presence of hydrogen gas. These lower temperatures have various beneficial effects, including lowering production cost through reduced energy usage and reduced lithium loss, and an increase in the quality of material produced due to decreased sintering during the calcination stage.

In some embodiments, a microwave plasma method and apparatus may be used to produce a material comprising very small particles of a multiphase material comprising lithium carbonate and one or more metal oxides. If this material is directly sintered a predominantly LLZO material may be formed. However, because of the gas generated by the carbonate during sintering, it is difficult to achieve a dense film of LLZO. In some embodiments, the processes described herein may produce a material that, when cast and sintered, generates almost no gas, and easily closes pores to be fully dense.

Thus, in some embodiments, an interstitial heat treatment step (i.e., calcination) may be used to decompose the lithium carbonate of the starting material to oxide prior to casting the material into a film. In some embodiments, it may be critical to keep particles small during this step, such that the particles cast well and easily sinter together into a film. When using standard conditions for this decomposition (e.g., 700° C. in an O₂ or N₂ atmosphere), there is significant sintering of the particles, such that the particles may grow from about 200 nm to about 1.5 um, with many particles fusing together. Thus, in some embodiments, the heat treatment comprises heating the starting material at a temperature below the melting point of lithium carbonate to prevent this growth and sintering. Generally, lithium carbonate does not decompose below its melting point. However, in some embodiments, when the heat treatment is undergone in the presence of hydrogen gas, it has been found that the lithium carbonate may decompose to lithium oxide with little particle growth at temperatures as low as 600° C., or even lower depending on the concentration of hydrogen gas. For example, the lithium carbonate may be decomposed at a temperature of 620° C. using 3% H₂ in nitrogen atmosphere. As a result, in some embodiments, the resulting material may be small enough in particle size to cast well into a dense film. In some embodiments, the materials may be capable of forming dense films achievable at lower calcination temperature, with less lithium loss and with less grain growth than a conventional process, at a lower cost.

Typical processes for LLZO material result in poor packing of material in green state, poor particle-to-particle contact, low driving force for sintering due to the large particle size, and poor coordination of particles with other particles. Green state can be defined as the particles after formation but before sintering. Rapid full density sintering of defect free separators may not occur when LLZO powder is produced via milling and/or spray pyrolysis. For example, separator films produced with LLZO prepared by these methods may have residual porosity and a large grain size distribution, which may result in early failures.

Superior LLZO can be made using starting materials produced by plasma processing, such as microwave plasma processing. LLZO that has been processed using starting materials produced by plasma processing may comprise spherical particles with tight size distribution (for example, between 20 nm-1000 nm), desired stoichiometry, and varied crystal structure. In some embodiments, LLZO prepared using the starting materials herein can have a fine particle size, which exhibits a greater driving force that densifies the material during sintering which promotes shorter sintering times, and a lower temperature compared with traditionally prepared LLZO materials. The tight particle size distribution and spherical morphology can allow for high packing fraction, which speeds up sintering. Further, the tight particle size and spherical morphology can reduce the occurrence of stable pores that cannot be sintered out. Less stable pores can lead to an increase in end quality of the material. The tight size distribution can also lead to controlled grain growth, which prevents abnormal growth that creates excessively large grains and broad grain size distribution.

### Plasma Processing

In some embodiments, the feedstock used to produce the starting materials for calcination can be metallic salts of the relevant elements such as nitrates and acetate of lithium, lanthanum, zirconium, tantalum, and aluminum. These salts can be dissolved and mixed at the right proportion to procure the desired stoichiometry. In some embodiments, a mixture of metallic salts can be used.

In some embodiments, nitrates of lanthanum, lithium, and aluminum can be mixed with acetates of zirconium to produce the solution feedstock and to produce the desired stoichiometry. In some embodiments, lithium hydroxide can be used as opposed to lithium nitrate to increase the lithium percentage in the salt. In some embodiments, other feedstocks used to produce starting materials for calcination material can be non-lithium containing ceramic powder particles of sizes ranging from 20-1000 nm mixed with a dispersion medium and in a carrier solution to produce a dispersion, suspension, slurry, or similar mixture. The carrier solution can be water, alcohols, or other non-polar solvents.

In some embodiments, lithium carbonate can be partially dissolved in the carrier solution and mixed with stoichiometric ratios of lanthanum oxide, zirconium oxide, and aluminum oxide mixed in water and a dispersion medium such as Triton X to form a stable suspension. In some embodiments, the dispersion or slurry can contain a combination of ceramic oxide powder mixed with a soluble metallic salt. Lithium nitrate and lanthanum nitrate can be mixed with zirconium and aluminum oxides in water to form a slurry.

A solution precursor may be formed by dissolving the metallic salts of interest of lithium, lanthanum, zirconium, and dopants, such as aluminum, in stoichiometric proportions in a solvent such as water or in the case of dispersions, dispersing the powders in the carrier solution. The quantity of each salt can be calculated to give the desired final stoichiometry of the LLZO material to be made. In the case of dopants, stoichiometry of the formula can be adjusted accordingly. In some embodiments, aluminum takes the place of lithium in the LLZO structure. In some embodiments, lithium or lanthanum may be vaporized during processing which can decrease the yield of metal in the final product. The amount of metallic salt can be increased to make up for the vaporized metal.

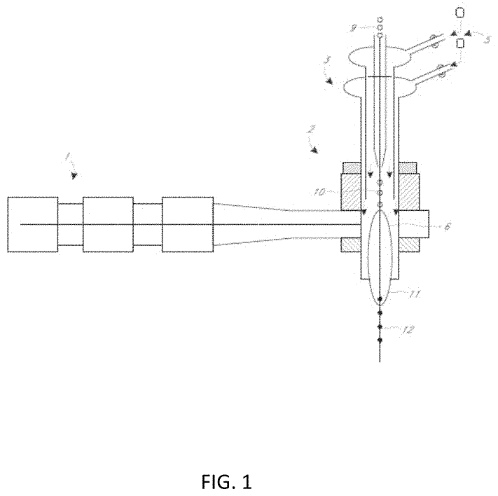

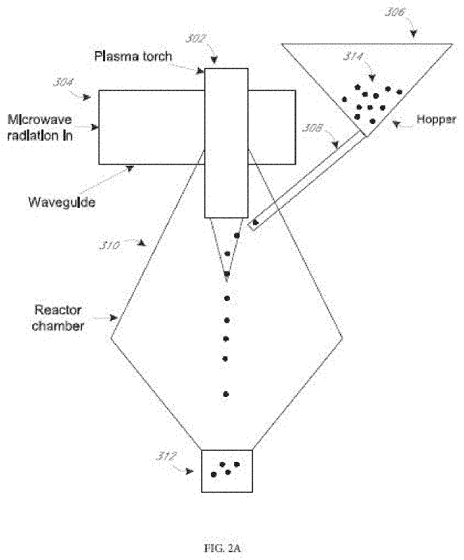

FIG. 1 illustrates an exemplary microwave plasma torch that can be used in the production of materials, according to embodiments of the present disclosure. As discussed above, feed materials 9, 10 can be introduced into a microwave plasma torch 2 in an introduction zone 3, the torch sustaining a microwave-generated plasma 11. In one example embodiment, an entrainment gas flow and a sheath flow (downward arrows) may be injected through inlets 5 to create flow conditions within the plasma torch 2 prior to ignition of the plasma 11 via microwave radiation source 1.

In some embodiments, the entrainment flow and sheath flow are both axis-symmetric and laminar, while in other embodiments the gas flows are swirling. The feed materials 9 are introduced axially into the microwave plasma torch 2, where they are entrained by a gas flow that directs the materials toward the plasma hot zone 6. As discussed above, the gas flows can consist of a noble gas column of the periodic table, such as helium, neon, argon, etc. Within the microwave-generated plasma, the feed materials are melted in order to spheroidize the materials. Inlets 5 can be used to introduce process gases to entrain and accelerate particles 9, 10 along axis 12 towards plasma 11. First, particles 9 are accelerated by entrainment using a core laminar gas flow (upper set of arrows) created through an annular gap within the plasma torch. A second laminar flow (lower set of arrows) can be created through a second annular gap to provide laminar sheathing for the inside wall of dielectric torch to protect it from melting due to heat radiation from plasma 11. In exemplary embodiments, the laminar flows direct particles 9, 10 toward the plasma 11 along a path as close as possible to axis 12, exposing them to a substantially uniform temperature within the plasma.

In some embodiments, suitable flow conditions are present to keep particles 10 from reaching the inner wall of the plasma torch 2 where plasma attachment could take place. Particles 9, 10 are guided by the gas flows towards microwave plasma 11 were each undergoes homogeneous thermal treatment. Various parameters of the microwave-generated plasma, as well as particle parameters, may be adjusted in order to achieve desired results. These parameters may include microwave power, feed material size, feed material insertion rate, gas flow rates, plasma temperature, residence time and cooling rates. In some embodiments, the cooling or quenching rate is not less than 10⁺³ degrees C./sec upon exiting plasma 11. As discussed above, in this particular embodiment, the gas flows are laminar; however, in alternative embodiments, swirl flows or turbulent flows may be used to direct the feed materials toward the plasma.

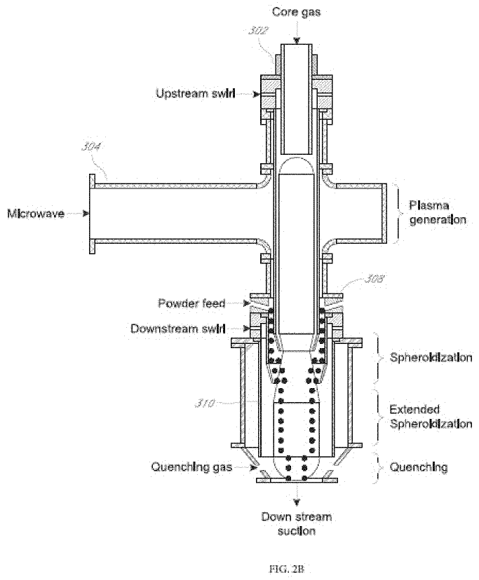

FIGS. 2A-B illustrates an exemplary microwave plasma torch that includes a side feeding hopper rather than the top feeding hopper shown in the embodiment of FIG. 1, thus allowing for downstream feeding. Thus, in this implementation the feedstock is injected after the microwave plasma torch applicator for processing in the “plume” or “exhaust” of the microwave plasma torch. Thus, the plasma of the microwave plasma torch is engaged at the exit end of the plasma torch to allow downstream feeding of the feedstock, as opposed to the top-feeding (or upstream feeding) discussed with respect to FIG. 1. This downstream feeding can advantageously extend the lifetime of the torch as the hot zone is preserved indefinitely from any material deposits on the walls of the hot zone liner. Furthermore, it allows engaging the plasma plume downstream at temperature suitable for optimal melting of powders through precise targeting of temperature level and residence time. For example, there is the ability to dial the length of the plume using microwave powder, gas flows, and pressure in the quenching vessel that contains the plasma plume.

Generally, the downstream spheroidization method can utilize two main hardware configurations to establish a stable plasma plume which are: annular torch, such as described in U.S. Pat. Pub. No. 2018/0297122, or swirl torches described in U.S. Pat. No. 8,748,785 B2 and U.S. Pat. No. 9,932,673 B2. A feed system close-coupled with the plasma plume at the exit of the plasma torch is used to feed powder axisymmetrically to preserve process homogeneity.

Other feeding configurations may include one or several individual feeding nozzles surrounding the plasma plume. The feedstock powder can enter the plasma at a point from any direction and can be fed in from any direction, 360° around the plasma, into the point within the plasma. The feedstock powder can enter the plasma at a specific position along the length of the plasma plume where a specific temperature has been measured and a residence time estimated for sufficient melting of the particles. The melted particles exit the plasma into a sealed chamber where they are quenched then collected.

The feed materials 314 can be introduced into a microwave plasma torch 302. A hopper 306 can be used to store the feed material 314 before feeding the feed material 314 into the microwave plasma torch 302, plume, or exhaust. The feed material 314 can be injected at any angle to the longitudinal direction of the plasma torch 302. 5, 10, 15, 20, 25, 30, 35, 40, 45, 50, or 55 degrees. In some embodiments, the feedstock can be injected an angle of greater than 5, 10, 15, 20, 25, 30, 35, 40, 45, 50, or 55 degrees. In some embodiments, the feedstock can be injected an angle of less than 5, 10, 15, 20, 25, 30, 35, 40, 45, 50, or 55 degrees. In alternative embodiments, the feedstock can be injected along the longitudinal axis of the plasma torch.

The microwave radiation can be brought into the plasma torch through a waveguide 304. The feed material 314 is fed into a plasma chamber 310 and is placed into contact with the plasma generated by the plasma torch 302. When in contact with the plasma, plasma plume, or plasma exhaust, the feed material melts. While still in the plasma chamber 310, the feed material 314 cools and solidifies before being collected into a container 312. Alternatively, the feed material 314 can exit the plasma chamber 310 while still in a melted phase to cool and solidify outside the plasma chamber. In some embodiments, a quenching chamber may be used, which may or may not use positive pressure. While described separately from FIG. 1, the embodiments of FIGS. 2A and 2B are understood to use similar features and conditions to the embodiment of FIG. 1.

As each droplet is heated within a plasma hot zone created by the microwave plasma torch, the solvents can evaporate, the solute can precipitate, and pyrolysis can occur. Pyrolysis under the oxygen plasma can produce an oxide compound made of lithium, lanthanum, zirconium, and dopant choices M1 and M2. The plasma gas can be oxygen but alternatively can be a blend of up to three gasses with a minimum oxygen concentration of 1%. In some embodiments, one of the up to three gasses is argon.

### Spheroidization

In some embodiments, the final particles achieved by the plasma processing can be spherical or spheroidal, terms that can be used interchangeably. Advantageously, by using the critical and specific disclosure relevant to each of the different feedstocks disclosed, all of the feedstocks can be transformed into the spherical powders.

Embodiments of the present disclosure are directed to producing particles that are substantially spherical or spheroidal or have undergone significant spheroidization. In some embodiments, spherical, spheroidal or spheroidized particles refer to particles having a sphericity greater than a certain threshold. Particle sphericity can be calculated by calculating the surface area of a sphere A_{s,ideal} with a volume matching that of the particle, V using the following equation:

$$\text{?} = \text{?}$$

$${A}_{s , ideal} = \text{?}$$

$$\text{?} \text{indicates text missing or illegible when filed}$$

and then comparing that idealized surface area with the measured surface area of the particle, A_{s,actual}:

$$Sphericity = \frac{{A}_{s , ideal}}{{A}_{s , actual}} .$$

In some embodiments, particles can have a sphericity (also referred to herein as sphericity factor) of greater than 0.5, 0.6, 0.7, 0.75, 0.8, 0.9, 0.91, 0.95, or 0.99 (or greater than about 0.5, about 0.6, about 0.7, about 0.75, about 0.8, about 0.8, about 0.91, about 0.95, or about 0.99). In some embodiments, particles can have a sphericity of 0.75 or greater or 0.91 or greater (or about 0.75 or greater or about 0.91 or greater). In some embodiments, particles can have a sphericity of less than 0.5, 0.6, 0.7, 0.75, 0.8, 0.9, 0.91, 0.95, or 0.99 (or less than about 0.5, about 0.6, about 0.7, about 0.75, about 0.8, about 0.8, about 0.91, about 0.95, or about 0.99). In some embodiments, a particle is considered to be spherical, spheroidal or spheroidized if it has a sphericity at or above any of the aforementioned sphericity values, and in some preferred embodiments, a particle is considered to be spherical if its sphericity is at or about 0.75 or greater or at or about 0.91 or greater.

In some embodiments, a median sphericity of all particles within a given powder can be greater than 0.5, 0.6, 0.7, 0.75, 0.8, 0.9, 0.91, 0.95, or 0.99 (or greater than about 0.5, about 0.6, about 0.7, about 0.75, about 0.8, about 0.8, about 0.91, about 0.95, or about 0.99). In some embodiments, a median sphericity of all particles within a given powder can be less than 0.5, 0.6, 0.7, 0.75, 0.8, 0.9, 0.91, 0.95, or 0.99 (or less than about 0.5, about 0.6, about 0.7, about 0.75, about 0.8, about 0.8, about 0.91, about 0.95, or about 0.99). In some embodiments, a powder is considered to be spheroidized if all or a threshold percentage (as described by any of the fractions below) of the particles measured for the given powder have a median sphericity greater than or equal to any of the aforementioned sphericity values, and in some preferred embodiments, a powder is considered to be spheroidized if all or a threshold percentage of the particles have a median sphericity at or about 0.75 or greater or at or about 0.91 or greater.

In some embodiments, the fraction of particles within a powder that can be above a given sphericity threshold, such as described above, can be greater than 50%, 60%, 70%, 80%, 90%, 95%, or 99% (or greater than about 50%, about 60%, about 70%, about 80%, about 90%, about 95%, or about 99%). In some embodiments, the fraction of particles within a powder that can be above a given sphericity threshold, such as described above, can be less than 50%, 60%, 70%, 80%, 90%, 95%, or 99% (or less than about 50%, about 60%, about 70%, about 80%, about 90%, about 95%, or about 99%).

Particle size distribution and sphericity may be determined by any suitable known technique such as by SEM, optical microscopy, dynamic light scattering, laser diffraction, manual measurement of dimensions using an image analysis software, for example from about 15-30 measures per image over at least three images of the same material section or sample, and any other techniques.

### EXAMPLES

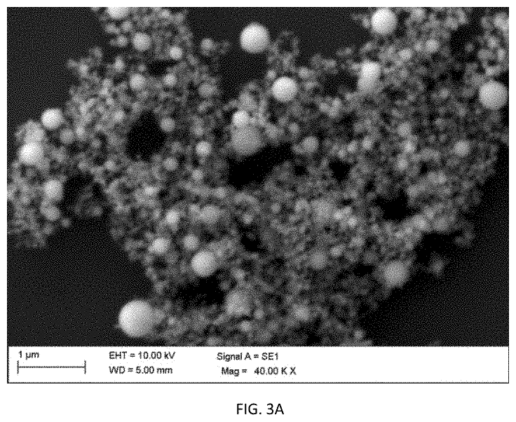

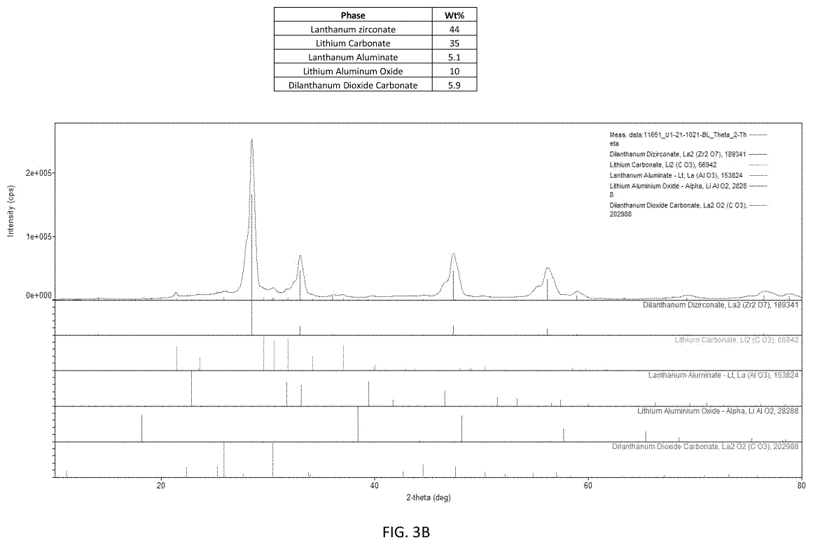

FIG. 3A is an electron micrograph of a multiphase starting material produced via a microwave plasma process according to some embodiments described herein. In some embodiments, using the processes described above, a spherical multiphase starting material may be synthesized having very small particle and comprising mixtures of carbonates and oxides within single particles.

FIG. 3B is a phase identification of a multiphase starting material produced via a microwave plasma process performed via X-ray diffraction according to some embodiments herein. As illustrated in FIG. 3B, in some embodiments, a multiphase material may be formed in which at least lanthanum zirconate, lithium carbonate, lanthanum aluminate, lithium aluminum oxide, and dilanthanum dioxide carbonate phases are present within single particles.

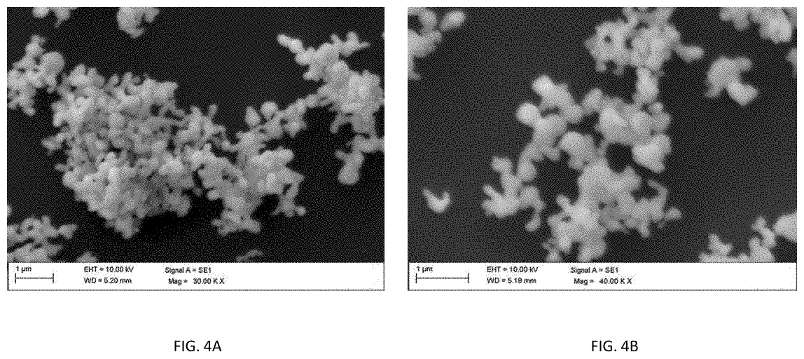

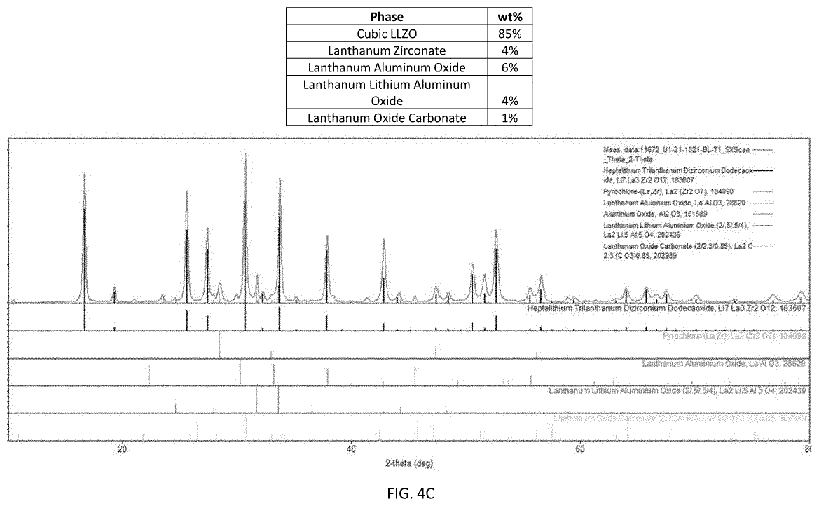

FIGS. 4A-B are electron micrographs of LLZO material calcined in the presence of hydrogen gas. As noted above, high-quality LLZO materials formed using plasma-processed, multiphase starting materials, which are calcined in the presence of hydrogen and then crystallized, may be produced. In particular, LLZO materials formed according to the methods described herein may comprise spherical particles with tight size distribution (for example, between 20 nm-1000 nm), desired stoichiometry, and varied crystal structure. In some embodiments, LLZO prepared using the starting materials herein can have a fine particle size, which exhibits a greater driving force that densifies the material during sintering which promotes shorter sintering times, and a lower temperature compared with traditionally prepared LLZO materials. The tight particle size distribution and spherical morphology can allow for high packing fraction, which speeds up sintering.

FIG. 4C is a phase identification of an LLZO material calcined in the presence of hydrogen gas performed via x-ray diffraction. As illustrated LLZO materials produced using the methods described herein may comprise various phases, but are generally at least about 75%, at least about 80%, at least about 85%, at least about 90%. At least about 95%, or at least about 99% LLZO by weight, with other phases including lanthanum, zirconate, lanthanum aluminum oxide, lanthanum lithium aluminum oxide, and very small amounts of lanthanum oxide carbonate.

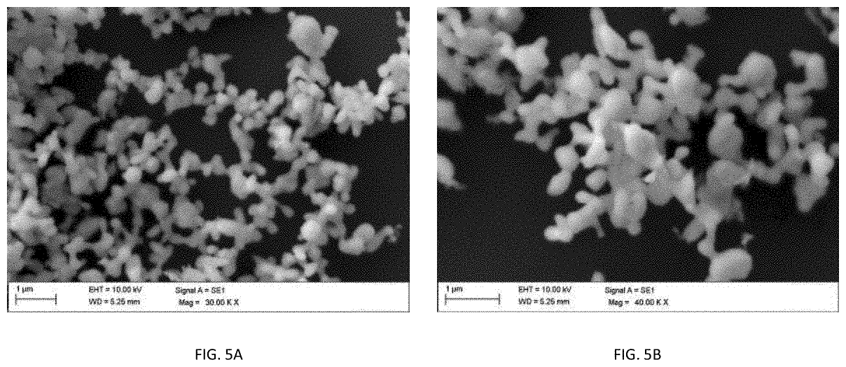

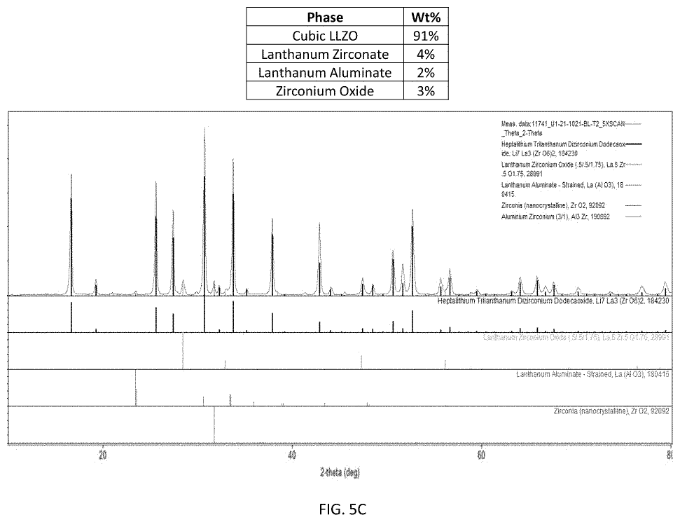

FIGS. 5A-B are electron micrographs of LLZO material calcined in the presence of hydrogen and oxygen gas according to some embodiments described herein. FIG. 5C is a phase identification of an LLZO material calcined in the presence of hydrogen and oxygen, performed via x-ray diffraction. In some embodiments, cubic LLZO may be formed using a calcination of plasma-processed multiphase material in the presence of hydrogen and oxygen gas. Other phases of the LLZO material may comprise lanthanum zirconate, lanthanum aluminate, and zirconium oxide.

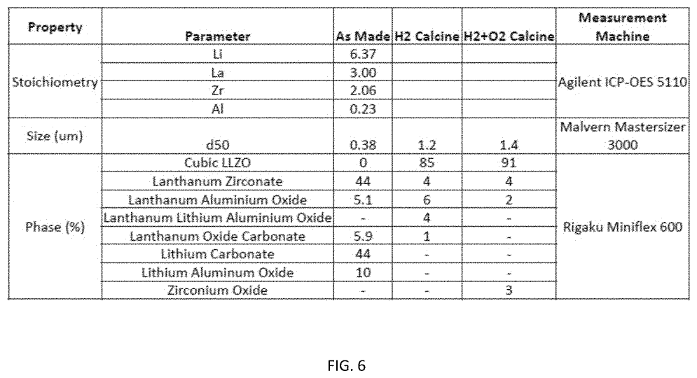

FIG. 6 illustrates a table summarizing the stoichiometric properties, particle size, and phases of an LLZO material according to some embodiments herein.

### Additional Embodiments

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than restrictive sense.

Indeed, although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the embodiments of the disclosed invention. Any methods disclosed herein need not be performed in the order recited. Thus, it is intended that the scope of the invention herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and subcombinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is necessary or indispensable to each and every embodiment.

It will also be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded the widest scope consistent with this disclosure, the principles and the novel features disclosed herein.

What is claimed is:

1. A method of producing lithium lanthanum zirconium oxide (LLZO) particles, the method comprising:
heating a multiphase material comprising lithium carbonate and La₂Zr₂O₇ in the presence of hydrogen gas at a temperature below the melting point of the lithium carbonate, such that at least a portion of the lithium carbonate decomposes to form lithium oxide; and
heating the lithium oxide to a temperature sufficient to crystallize the lithium oxide to form lithium lanthanum zirconium oxide (LLZO) particles.

2. The method of claim 1, wherein the LLZO further comprises one or more dopants.

3. The method of claim 2, wherein the one or more dopants comprise at least one of aluminum (Al), tantalum (Ta), niobium (Nb), gallium (Ga), and boron (B).

4. The method of claim 1, wherein the LLZO comprises at least one of LaAlO₃ or La₂(Li_{0.5}Al_{0.5})O₄.

5. The method of claim 1, wherein the multiphase material further comprises at least one of LiAlLaO₂, Li₂ZrO₃, ZrO₂, LaAlO₃, La₂O₃, La₂(Li_{0.5}Al_{0.5})O₄, LiLaO₂, Li₅AlO₄, La₂O₂CO₃, or LiₐZr_{b}O_{c} where 1≤a≤8, 1≤b≤2, and 1≤c≤7.

6. The method of claim 1, wherein the portion of the lithium carbonate that decomposes to form lithium oxide is at least 50% by weight of the lithium carbonate in the multiphase material.

7. The method of claim 1, wherein the portion of the lithium carbonate that decomposes to form lithium oxide is at least 75% by weight of the lithium carbonate in the multiphase material.

8. The method of claim 1, wherein the portion of the lithium carbonate that decomposes to form lithium oxide is at least 90% by weight of the lithium carbonate in the multiphase material.

9. The method of claim 1, wherein the portion of the lithium carbonate that decomposes to form lithium oxide is at least 99% by weight of the lithium carbonate in the multiphase material.

10. The method of claim 1, further comprising forming a thin film from the LLZO particles.

11. The method of claim 1, wherein at least a portion of the lithium carbonate forms lithium peroxide upon heating the multiphase material.

12. The method of claim 1, wherein the lithium oxide is heated at a temperature above 600° C.

13. The method of claim 1, wherein the lithium oxide is heated to a temperature above 640° C.

14. The method of claim 1, wherein the lithium oxide is heated in oxygen-containing atmosphere.

15. The method of claim 1, wherein the lithium oxide is heated in the absence of hydrogen gas.

16. The method of claim 1, wherein an amount of lithium loss that occurs during the method is less than 3% by weight.

17. The method of claim 1, further comprising forming the multiphase material using a microwave plasma process comprising:
inputting one or more feedstock materials into a microwave generated plasma to form the multiphase material; and
collecting the multiphase material.

18. A multiphase material comprising lithium carbonate and lanthanum zirconate within a single particle of the multiphase material.

19. The multiphase material of claim 18, wherein the multiphase material is formed by a process comprising:
preparing a feedstock comprising lanthanum and zirconium;
introducing the feedstock into a microwave plasma torch, a plasma plume of the microwave plasma torch, and/or an exhaust of the microwave plasma torch; and
heating the feedstock within the microwave plasma torch, the plasma plume of the microwave plasma torch, and/or the exhaust of the microwave plasma torch to form the multiphase material.

20. A lithium lanthanum zirconium oxide (LLZO) material formed by a method comprising:
heating a multiphase material comprising lithium carbonate and La₂Zr₂O₇ in the presence of hydrogen gas at a temperature below the melting point of the lithium carbonate, such that at least a portion of the lithium carbonate decomposes to form lithium oxide; and
heating the lithium oxide to a temperature sufficient to crystallize the lithium oxide to form lithium lanthanum zirconium oxide (LLZO) particles.
